(19) United States
(12) Patent Application Publication
(10) Pub. No.: US 2012/0050284 A1
(43) Pub. Date: Mar. 1, 2012

(54) METHOD AND APPARATUS FOR IMPLEMENTING THREE-DIMENSIONAL IMAGE

(75) Inventor: Sang-Jun AHN, Seoul (KR)

(73) Assignee: Samsung Electronics Co., Ltd., Suwon-si (KR)

(21) Appl. No.: 13/219,114

(22) Filed: Aug. 26, 2011

(30) Foreign Application Priority Data
Aug. 27, 2010 (KR) 10-2010-0083531

(51) Int. Cl. G06T 15/00

(52) U.S. Cl. 345/419

(57) ABSTRACT

Provided is a method and an apparatus for implementing a three-dimensional web page which includes determining whether an original image is a web page, distinguishing a text area displaying text from a multimedia area displaying multimedia information excluding the text, in a source code document for the web page, when the original image is the web page image; generating a depth map based on tags included in the text area, and generating a three-dimensional stereoscopic image by using the depth map.

### PRIORITY

This application claims priority under 35 U.S.C. §119(a) to a Korean Patent Application No. 10-2010-0083531, which was filed in the Korean Intellectual Property Office on Aug. 27, 2010, the entire disclosure of which is incorporated herein by reference.

### BACKGROUND OF THE INVENTION

1. Field of the Invention

The present invention relates generally to the implementation of a three-dimensional stereoscopic image, and more particularly to a method and an apparatus for implementing a three-dimensional stereoscopic web page.

2. Description of the Related Art

In recent years, research has focused on a scheme for implementing a three-dimensional image in the field of image technology. Such a three-dimensional image can be used to express image information more realistically and vividly than a two-dimensional image.

Generally, a three-dimensional effect is achieved through a method, in which after the left visual point image and the right visual point image are scanned at their corresponding locations on an existing display apparatus by using the human eye's visual perception characteristics, the left visual point and the right visual point are separately imaged on the left eye and the right eye of a viewer, so that the viewer can perceive a three-dimensional effect.

FIG. 1 is a diagram illustrating an operation for displaying a three-dimensional image. Generally, a mobile communication terminal, which includes a barrier Liquid Crystal Display (LCD) employing a parallax barrier scheme to display a three-dimensional image, can freely display not only an existing two-dimensional image but also a three-dimensional stereoscopic image. This mobile communication terminal can implement not only the existing two-dimensional image but also the same stereo image as a three-dimensional structure that the human eyes perceive. Specifically, a stereo image, which is a three-dimensional stereoscopic image using an image from the left visual point and an image from the right visual point, includes a left image and a right image, which are combined into one and then stored in step 101. The left image and the right image are subjected to a process for interleaving in step 102. Then, a three-dimensional stereoscopic image 104 is displayed by a terminal 103 including a barrier LCD.

FIG. 2 is a diagram illustrating an operation for converting a two-dimensional image to a three-dimensional image. A method for converting two-dimensional content to a three-dimensional structure includes the following steps. First, a first original two-dimensional image 201 is parsed to generate a depth map 202, and then a right view 204 is generated by using information on the depth map 202. Next, a three-dimensional stereoscopic image is generated by using the newly-generated right view 204 and a left view 203 corresponding to the original two-dimensional image. One example of a method for converting a two-dimensional image to a three-dimensional stereo image, as described above, is disclosed in “Converting Two-dimensional Video into Stereo Video” (U.S. Publication No. 2010/0111417).

At present, such a technology for converting a two-dimensional image to a three-dimensional stereoscopic image treats all two-dimensional content as images used to compute a depth map, and then generates a right (or left) view, which is different from the original image, by using the computed depth map. However, in a web page, text areas displaying text correspond to most areas excluding a multimedia area displaying an image or a moving image, and all the text areas are set to have the same depth when calculations are performed. Therefore, a problem in the existing method for implementing a three-dimensional image is in the difficulty of creating a three-dimensional effect.

### SUMMARY OF THE INVENTION

Accordingly, the present invention has been made to solve the above-mentioned problems occurring in the prior art, and the present invention provides a method and an apparatus for implementing a three-dimensional web page, by which a typical web page can be expressed in three dimensions.

In accordance with an aspect of the present invention, there is provided a method for implementing a three-dimensional web page, which includes determining whether an original input image is an image of a web page; distinguishing a text area displaying text from a multimedia area displaying multimedia information excluding the text, in a source code document for the web page when the original input image is the image of the web page; generating a depth map for each type of tags in the text area; and generating a three-dimensional stereoscopic image by using the depth map.

In accordance with another aspect of the present invention, there is provided an apparatus for implementing a three-dimensional web page, which includes an image processor for determining whether an original input image is an image of a web page, and distinguishing a text area displaying text from a multimedia area displaying multimedia information excluding the text, in a source code document for the web page when the original input image is the image of the web page; a depth map generator for generating a depth map for each type of tags in the text area; and a three-dimensional image generator for generating a three-dimensional stereoscopic image by using the depth map.

### BRIEF DESCRIPTION OF THE DRAWINGS

The above and other features, aspects, and advantages of the present invention will be more apparent from the following detailed description taken in conjunction with the accompanying drawings, in which:

FIG. 1 is a diagram illustrating an operation for displaying an existing three-dimensional image;

FIG. 2 is a diagram illustrating an operation for converting an existing two-dimensional image to a three-dimensional image;

FIG. 3 is a flowchart illustrating an operation for converting a two-dimensional image to a three-dimensional image according to an embodiment of the present invention;

FIG. 4 is a diagram illustrating an example of a basic structure of a typical HTML (Hyper Text Markup Language) document;

FIG. 5 is a diagram illustrating an example of an HTML document for displaying typical text;

FIG. 6 is a block diagram illustrating the configuration of an apparatus for converting a two-dimensional image to a three-dimensional image according to an embodiment of the present invention; and

FIG. 7 is a diagram illustrating an example of a web page which is converted to a three-dimensional image and is then displayed according to an embodiment of the present invention.

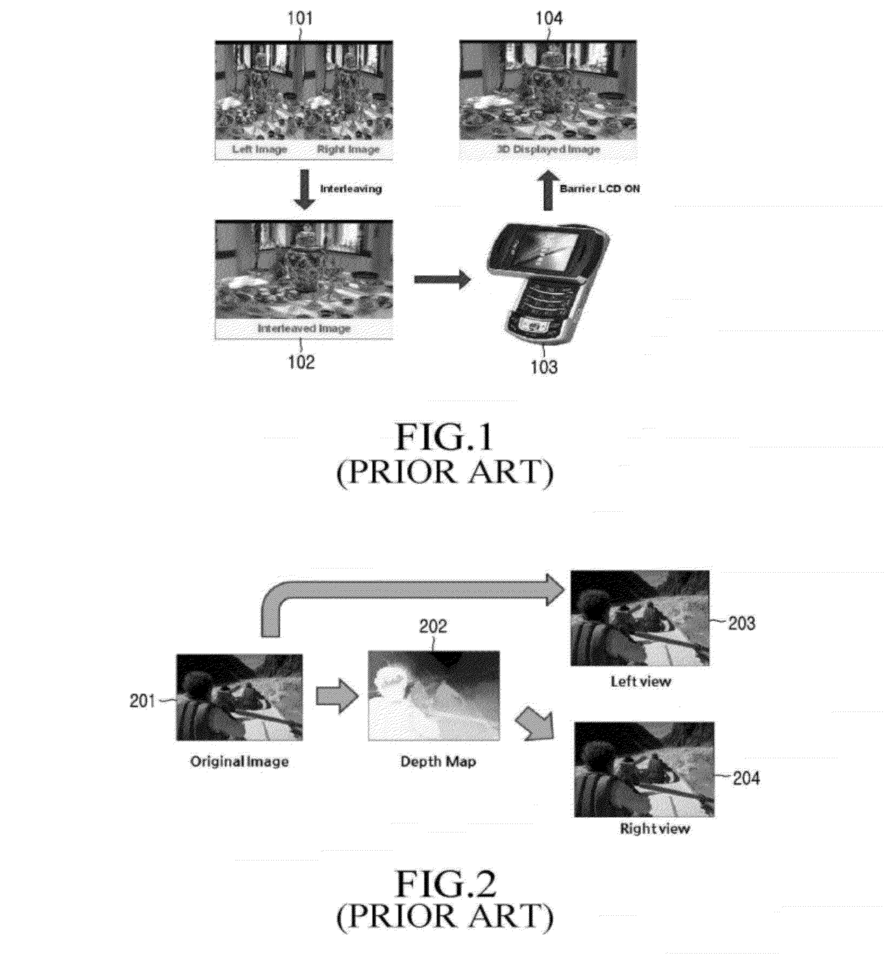

### DETAILED DESCRIPTION OF THE EMBODIMENTS OF THE PRESENT INVENTION

Hereinafter, the present invention will be described in detail with reference to the accompanying drawings, in which aspects of the present invention are illustrated. The following description includes specific details which are only provided to aid the general understanding of the present invention. Therefore, it will be apparent to a person having ordinary skill in the art that variations and modifications may be made in the specific details without departing from the scope of the present invention. Also, detailed descriptions of well-known techniques related to the present invention may be omitted to avoid unnecessarily obscuring the subject matter of the present invention.

The present invention provides a method for implementing a three-dimensional stereoscopic image by converting a two-dimensional image to a three-dimensional image. Specifically, the present invention implements an image of a two-dimensional web page in three dimensions, by parsing a Hyper Text Markup Language (HTML) web document and then using depth information for each type of tags in a text area, a depth map is generated, and then a three-dimensional image is generated by using the generated depth map.

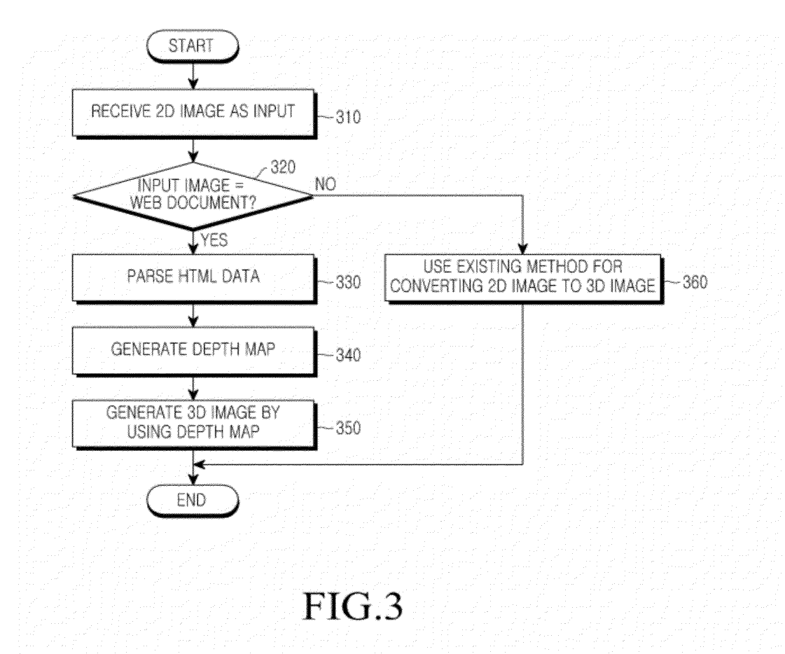

FIG. 3 is a flowchart illustrating an operation for converting a two-dimensional image to a three-dimensional image according to an embodiment of the present invention.

Referring to FIG. 3, when an original image is first input in step 310, it is determined in step 320 whether the input image is an image of a web page.

When a result of the determination in step 320 shows that the input image is not an image of a web page, the process proceeds to step 360. In step 360, the input image is converted to a three-dimensional image by using a conventional method for converting a two-dimensional image to a three-dimensional image, and then the process is completed. In this case, a process for generating a depth map for the input image and then converting the input image to a three-dimensional image by using the generated depth map is performed.

When the result of the determination in step 320 shows that the input image is an image of a web page, the process proceeds to step 330. In step 330, data of a document, which has been written in HTML or XML, for implementing a web page is parsed.

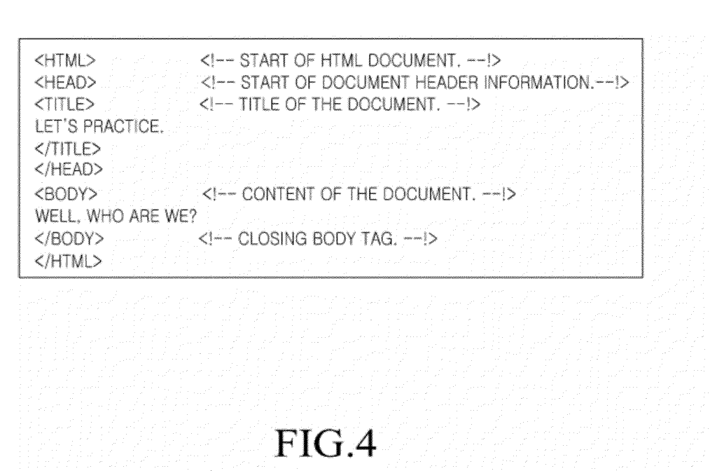

FIG. 4 is a diagram illustrating an example of a basic structure of a typical HTML document. Generally, an HTML web page document consists of a head and a body as shown in FIG. 4. The head includes information on the document, and the body includes the content of the web page such as multimedia information, text and images. An HTML tag is configured in the format of <xxxx> (information) </xxxx>. For example, as shown in FIG. 4, content to be displayed in a title bar are input between the title start tag “<TITLE>” and title end tag “</TITLE>,” and the content of the body of an HTML document is input between the body start tag “<BODY>” and the body end tag “</BODY>.”

Next, in step 340, a depth map is generated by using information obtained by parsing the data of the source code document for the web page. Specifically, the HTML source code document for the web page is first parsed, and then, a text area displaying text information is distinguished from a multimedia area displaying multimedia information excluding the text, in the web page. Next, for the multimedia area in the HTML document, a depth map is computed by using the existing method for converting a two-dimensional image to a three-dimensional image as described above. For the image, a depth map is generated corresponding to the multimedia area displaying the multimedia information in the original input image, and then an image in the multimedia area is converted to a three-dimensional image by using the generated depth map. For the text area, a depth map is generated by using tag information of the source code document for the web page according to the features of the present invention.

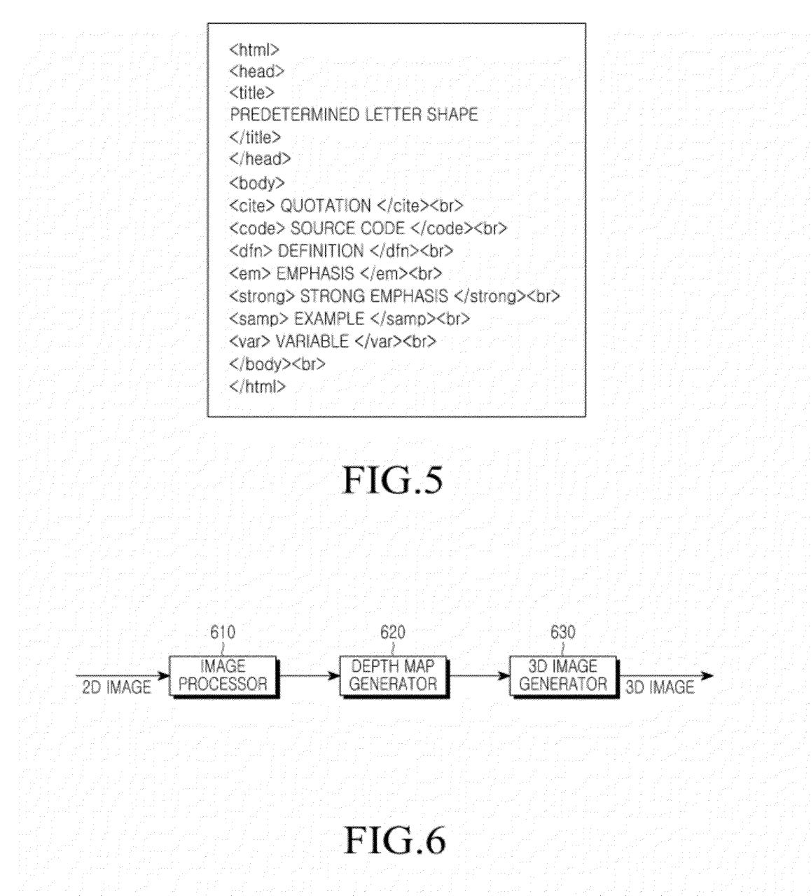

FIG. 5 is a diagram illustrating an example of an HTML document for displaying basic text. Referring to FIG. 5, a web document normally uses many types of tags. According to one aspect of the present invention, depth information corresponding to each type of the tags is set, and a depth map is generated by automatically setting depth information for each type of the tags used in a web document. For example, depth information may be set for a <cite> tag indicating a quotation or a <strong> tag indicating more emphasis relative to the regular text, which will appear to be forward protruding. A depth map of a text area is generated by using the depth information which has been set for each type of the tags as described above. Multiple aspects of the depth information according to the types of the tags may be pre-stored in the form of a table. Additionally, the depth information corresponding to each type of the tags may be optionally set by a user. For example, depth information may be set for a title or an important section of text in such a manner as to appear to be more protruding than text excluding the title or the important section.

Next, in step 350, a right view is generated by using the depth map generated in step 340, and then a three-dimensional image is generated by using both the generated right view and the original image as the left view, using the method for generating a three-dimensional image by using the depth map.

Additionally, when the web document is parsed and the depth map is generated in steps 330 and 340, a depth map may be generated by using not only the method using the depth information preset for each type of the tags but also a new tag (e.g. <depth> (depth information) </depth>) which is additionally defined in order to give depth information to a particular part of a document.

FIG. 6 is a block diagram illustrating an apparatus for converting a two-dimensional image to a three-dimensional image according to an embodiment of the present invention.

Referring to FIG. 6, an apparatus for converting a two-dimensional image to a three-dimensional image includes an image processor 610, a depth map generator 620, and a three-dimensional image generator 630.

The image processor 610 determines whether an input two-dimensional image is an image of a web page. When the input two-dimensional image is an image of the web page, the image processor 610 parses the web page document written in HTML or XML, and then distinguishes, in the web page, a text area displaying text information from a multimedia area displaying multimedia information excluding the text.

Whether the input two-dimensional image is not an image of the web page or the input two-dimensional image is an image of the web page, the depth map generator 620 generates a depth map for the multimedia area in the web page by using the method for converting a two-dimensional image to a three-dimensional image. When the input two-dimensional image is an image of the web page, the depth map generator 620 generates a depth map for a text area in the document for implementing the relevant web page by using the depth information preset for each type of the tags, according to the present invention. The depth information may be preset for each type of the tags, and a new tag for setting depth information may be defined and then be used. The depth map generator 620 may previously store multiple pieces of the depth information according to the types of the tags, which are used in the text area of the web document, in the form of a table.

The three-dimensional image generator 630 generates a right view by using the depth map generated by the depth map generator 620, and then generates a three-dimensional image by using both the generated right view and the original image as the left view. The method for generating a three-dimensional image by using the depth map is used.

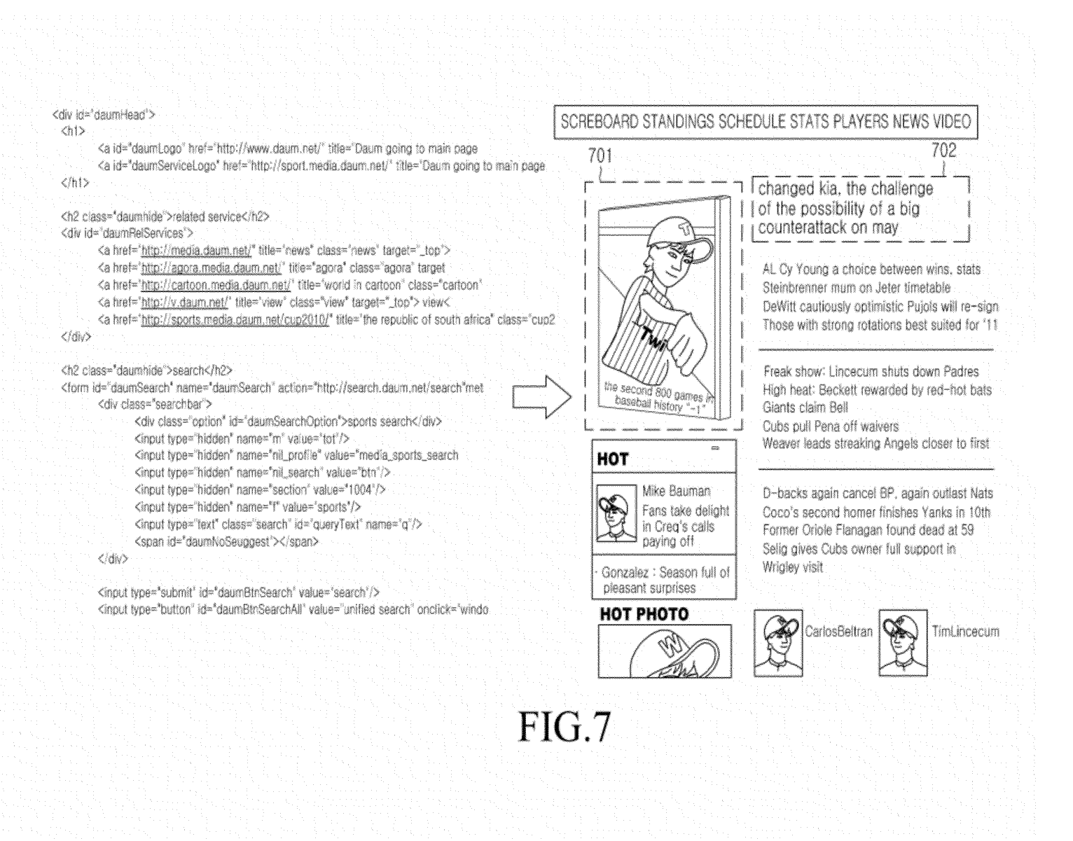

FIG. 7 is a diagram illustrating an example of a web page which is converted to a three-dimensional image and displayed, according to an embodiment of the present invention.

As shown in FIG. 7, the web page may be converted to a three-dimensional image by using a web document. Referring to FIG. 7, a multimedia area 701 is displayed as a three-dimensional image by using a general method for converting a two-dimensional image to a three-dimensional image, and a text area is displayed as a three-dimensional image according to the depth information preset for each type of the tags. The depth information is set for each type of tags in the text area, and then text, such as a headline area 702 representing news, which is determined to be more important than other areas, may be displayed as a three-dimensional image of the web page in order to create a more three-dimensional effect.

The existing method for converting a two-dimensional image to a three-dimensional image is an image-based method, and thus does not fit for expressing a web page, in which text is the main focus, in three dimensions. Specifically, when the existing conversion method is used, there is no three-dimensional effect since all the text areas are set to have the same depth. Accordingly, in the present invention, a web document such as an HTML or XML document, is parsed and then a depth map is generated by using depth information which is set for each type of the tags. Therefore, different three-dimensional effects are given depending on the importance of text, so that a three-dimensional effect can be given to a web page.

Additionally, depth information of an image of the web page may be directly adjusted, when a new HTML document or a new XML document is written, by using a new tag for setting a three-dimensional degree in the document.

While the present invention has been shown and described with reference to various embodiments thereof, various changes in form and detail may be made, for example in the format of a document for implementing a web page, such as an XML document, or a document of a word processor, or another well-known format, without departing from the spirit and scope of the present invention as defined by the appended claims.

What is claimed is:

1. A method for implementing a three-dimensional web page, the method comprising:
determining whether an original image is a web page image;
distinguishing a text area displaying text from a multimedia area displaying multimedia information excluding the text, in a source code document for the web page when the original image is the web page image;
generating a depth map based on tags included in the text area; and
generating a three-dimensional stereoscopic image by using the depth map.

2. The method as claimed in claim 1, wherein the source code document for the web page includes a Hyper Text Markup Language (HTML) document or an Extensible Markup Language (XML) document.

3. The method as claimed in claim 1, further comprising:
generating a multimedia depth map for an image corresponding to the multimedia area;
displaying the multimedia information in the original image; and
converting an image in the multimedia area to a three-dimensional image by using the multimedia depth map.

4. The method as claimed in claim 1, wherein the depth map based on the tags in the text area is generated by using depth information of a relevant tag preset for each type of the tags included in the text area.

5. The method as claimed in claim 1, wherein the depth map based on the tags in the text area is generated by using a tag defined to give depth information to a particular part of the web page.

6. An apparatus for implementing a three-dimensional web page, the apparatus comprising:
an image processor for determining whether an original image is a web page image, and distinguishing a text area displaying text from a multimedia area displaying multimedia information excluding the text, in a source code document for the web page, when the original image is the web page image;
a depth map generator for generating a depth map based on tags included in the text area; and
a three-dimensional image generator for generating a three-dimensional stereoscopic image by using the depth map.

7. The apparatus as claimed in claim 6, wherein the source code document for the web page includes a Hyper Text Markup Language (HTML) document or an Extensible Markup Language (XML) document.

8. The apparatus as claimed in claim 6, wherein the depth map generator generates a multimedia depth map for an image corresponding to the multimedia area displaying the multimedia information in the original image, and converts an image in the multimedia area to a three-dimensional image by using the multimedia depth map.

9. The apparatus as claimed in claim 6, wherein the depth map generator generates the depth map by using depth information of a relevant tag preset for each type of tag included in the text area.

10. The apparatus as claimed in claim 9, wherein the depth map generator stores the depth information of the relevant tag.

11. The apparatus as claimed in claim 6, wherein the depth map generator generates the depth map by using a tag defined to give depth information to a particular part of the web page.
